(19) United States
(12) Patent Application Publication
(10) Pub. No.: US 2025/0370877 A1
(43) Pub. Date: Dec. 4, 2025

(54) AUTOMATED SNAPSHOT MANAGEMENT FOR DATA STORAGE DEVICE ARRAYS

(71) Applicant: Western Digital Technologies, Inc., San Jose, CA (US)

(72) Inventors: Puspanjali Panda, Bangalore (IN); Ankit Rajani, Bangalore (IN); Pavan Gururaj, Bangalore (IN); Dinesh Babu, Bangalore (IN)

(21) Appl. No.: 18/677,096

(22) Filed: May 29, 2024

(51) Int. Cl. G06F 11/14

(52) U.S. Cl. CPC G06F 11/1448; G06F 2201/84

(57) ABSTRACT

Systems and methods for automated snapshot management in data storage device arrays are described. An array of data storage devices may be identified having corresponding namespaces defined in the data storage devices for storing host data. A snapshot namespace may be created across the array of data storage devices and snapshots of the host namespaces may be stored to the snapshot namespace distributed among the data storage devices. A snapshot management data structure may be generated with namespace metadata and snapshot metadata and redundantly stored among the data storage devices in the array or across enclosure managers for multiple enclosures. Snapshot creation and updating may be initiated by detection of failure conditions impacting the array and initiate an automated process for initial snapshots, incremental updates, and offloading to cloud-based storage systems.

### TECHNICAL FIELD

The present disclosure generally relates to storage systems supporting high data availability for data storage device arrays and, more particularly, to automated snapshot management for flash arrays using non-volatile memory express (NVMe) namespaces.

### BACKGROUND

In modern data storage environments, Just a Bunch Of Flash (JBOF) systems have become prevalent due to their high performance and capacity benefits. These systems typically utilize Non-Volatile Memory express (NVMe) and/or NVMe-over-Fabric (NVMe-oF) protocols to optimize the speed and efficiency of data transfers. However, JBOF systems, like all complex storage solutions, are not immune to failures that can lead to data loss or service interruptions. Such failures may include power outages, drive malfunctions, connectivity issues, and cooling system failures, among others.

Traditional data protection strategies, such as regular backups and RAID configurations, provide a foundational level of security but often fall short in meeting the demands of modern data centers. These methods can be resource-intensive and may not offer the rapid recovery times necessitated by services that require high availability and real-time data processing.

Snapshot technology presents a more dynamic and efficient approach to data protection, allowing for the quick capture of storage system states and facilitating faster recovery times. However, managing snapshots in JBOF environments poses its own set of challenges. The complexity arises from the multitude of drives, the high rate of data change, and the desire for integration with cloud-based storage solutions for offsite data protection and disaster recovery.

There is a clear demand for an automated, efficient, and reliable snapshot management system tailored for JBOF environments, particularly one that can seamlessly integrate with cloud storage services. Such a system would enhance data protection, streamline the backup and recovery process, and mitigate the impact of storage system failures.

### SUMMARY

Various aspects for automated snapshot management for data storage device arrays, such as JBOF arrays, are described. More particularly, an enclosure manager that creates and manages automated snapshots to a virtual namespace distributed across the drives in the array may be configured to respond to failures and proactively manage the snapshot space and related metadata based on the usage of the various host namespaces on those drives.

One general aspect includes a system that includes at least one memory and at least one processor configured to, alone or in combination, execute instructions to: determine a plurality of data storage devices may include a plurality of host namespaces configured to store host data; create, on each data storage device among the plurality of data storage devices, a snapshot namespace configured to store snapshots of host data stored in the plurality of host namespaces; capture, for each host namespace, an initial snapshot to determine a set of initial snapshots for the plurality of host namespaces; store the set of initial snapshots to the snapshot namespace distributed among the plurality of data storage devices; and store a snapshot management data structure that includes namespace metadata for the plurality of host namespaces and snapshot metadata for the set of initial snapshots.

Implementations may include one or more of the following features. The at least one processor may be further configured to, alone or in combination, execute instructions to: monitor the plurality of data storage devices for at least one failure condition; detect the at least one failure condition; and automatically initiate, responsive to detecting the at least one failure condition, capturing the initial snapshots for the set of initial snapshots for the plurality of host namespaces. The at least one processor may be further configured to, alone or in combination, execute instructions to, responsive to determining the set of initial snapshots for the plurality of host namespaces: monitor the plurality of host namespaces to determine host data changes in at least one host namespace of the plurality of host namespaces; capture, for each host namespace of the at least one host namespace having the host data changes, an updated snapshot to determine a set of update snapshots for the plurality of host namespaces; store the set of update snapshots to the snapshot namespace distributed among the plurality of data storage devices; and update the snapshot management data structure with changes to the namespace metadata for the plurality of host namespaces and the snapshot metadata for the set of initial snapshots. The at least one processor may be further configured to, alone or in combination, execute instructions to: determine, for each host namespace, a host namespace type for that host namespace; determine, for the snapshot namespace, a snapshot namespace type that is different from the host namespace type of at least one host namespace of the plurality of host namespaces; and convert, prior to storing the host data from the at least one host namespace having the host namespace type that is different from the snapshot namespace type to the set of initial snapshots, host data mapping for that host namespace type to host data mapping for the snapshot namespace type. The host namespace type for the at least one host namespace having the host namespace type that is different from the snapshot namespace type may be a block storage namespace type; and the snapshot namespace type may be a sequential write namespace type selected from a zoned namespace type and a key-value namespace type. The at least one processor may be further configured to, alone or in combination, execute instructions to: determine, for each host namespace of the plurality of host namespaces, a set of namespace parameters; classify, based on the set of namespace parameters for each host namespace, a usage classification for that host namespace; sort the plurality of host namespaces by their usage classifications; and determine, based on the sorted plurality of host namespaces, a snapshot creation order for the set of initial snapshots that determines sequential storage of the set of initial snapshots in the snapshot namespace. The at least one processor may be further configured to, alone or in combination, execute instructions to determine a snapshot allocation value for each data storage device of the plurality of data storage devices. The snapshot namespace may include, for each data storage device of the plurality of data storage devices, a portion of a capacity of that data storage device based on the snapshot allocation value. The at least one processor may be further configured to, alone or in combination, execute instructions to replicate the snapshot management data structure across multiple storage locations selected from: non-volatile memory in each data storage device of the plurality of data storage devices; and non-volatile memory in each storage enclosure of a plurality of storage enclosures that include the plurality of data storage devices. The system may further include a storage enclosure that includes: a network interface in communication with a cloud-based storage system configured to store offloaded snapshot data; the plurality of data storage devices; the at least one memory; and the at least one processor. The at least one processor may be further configured to, alone or in combination, execute instructions to: determine a set of credentials for the cloud-based storage system; embed the snapshot management data structure with the set of initial snapshots; and store the snapshot management data structure and the set of initial snapshots to the cloud-based storage system. Each data storage device of the plurality of data storage devices may be a solid state drive that includes: a non-volatile storage medium; a device controller configured to control storage operations to the non-volatile storage medium; and a storage interface port configured to connect to a storage interface bus of the storage enclosure. The storage enclosure may further include: at least one power interface configured to provide power to the plurality of data storage devices; at least one fan configured to cool the plurality of data storage devices; and an enclosure manager stored in the at least one memory for execution by the at least one processor, alone or in combination, to monitor for a plurality of failure conditions selected from: failure of at least one data storage device of the plurality of data storage devices; failure of at least one port connected to the storage interface bus; failure of at least one power connection to at least one data storage device through the at least one power interface; and failure of the at least one fan.

Another general aspect includes a computer-implemented method that includes: determining a plurality of data storage devices may include a plurality of host namespaces configured to store host data; creating, on each data storage device among the plurality of data storage devices, a snapshot namespace configured to store snapshots of host data stored in the plurality of host namespaces; capturing, for each host namespace, an initial snapshot to determine a set of initial snapshots for the plurality of host namespaces; storing the set of initial snapshots to the snapshot namespace distributed among the plurality of data storage devices; and storing a snapshot management data structure that includes namespace metadata for the plurality of host namespaces and snapshot metadata for the set of initial snapshots.

Implementations may include one or more of the following features. The computer- implemented method may include: monitoring the plurality of data storage devices for at least one failure condition; detecting the at least one failure condition; and automatically initiating, responsive to detecting the at least one failure condition, capturing the initial snapshots for the set of initial snapshots for the plurality of host namespaces. The computer-implemented method may include, responsive to determining the set of initial snapshots for the plurality of host namespaces: monitoring the plurality of host namespaces to determine host data changes in at least one host namespace of the plurality of host namespaces; capturing, for each host namespace of the at least one host namespace having the host data changes, an updated snapshot to determine a set of update snapshots for the plurality of host namespaces; determining, for at least one host namespace having the host data changes, at least one changed data unit for sequentially updating a previously stored snapshot for the at least one host namespace having the host data changes; storing the set of update snapshots to the snapshot namespace distributed among the plurality of data storage devices; and updating the snapshot management data structure with changes to the namespace metadata for the plurality of host namespaces and the snapshot metadata for the set of initial snapshots. The computer-implemented method may include: determining, for each host namespace, a host namespace type for that host namespace; determining, for the snapshot namespace, a snapshot namespace type that is different from the host namespace type of at least one host namespace of the plurality of host namespaces; and converting, prior to storing the host data from the at least one host namespace having the host namespace type that is different from the snapshot namespace type to the set of initial snapshots, host data mapping for that host namespace type to host data mapping for the snapshot namespace type. The host namespace type for the at least one host namespace having the host namespace type that is different from the snapshot namespace type may be a block storage namespace type; and the snapshot namespace type may be a sequential write namespace type selected from a zoned namespace type and a key-value namespace type. The computer-implemented method may include: determining, for each host namespace of the plurality of host namespaces, a set of namespace parameters; classifying, based on the set of namespace parameters for each host namespace, a usage classification for that host namespace; sorting the plurality of host namespaces by their usage classifications; and determining, based on the sorted plurality of host namespaces, a snapshot creation order for the set of initial snapshots that determines sequential storage of the set of initial snapshots in the snapshot namespace. The computer-implemented method may include determining a snapshot allocation value for each data storage device of the plurality of data storage devices. The snapshot namespace may include, for each data storage device of the plurality of data storage devices, a portion of a capacity of that data storage device based on the snapshot allocation value. The computer-implemented method may include replicating the snapshot management data structure across multiple storage locations selected from: non-volatile memory in each data storage device of the plurality of data storage devices; and non-volatile memory in each storage enclosure of a plurality of storage enclosures may include the plurality of data storage devices. The computer-implemented method may include: determining a set of credentials for a cloud-based storage system in communication with a storage enclosure may include the plurality of data storage devices; embedding the snapshot management data structure with the set of initial snapshots; and storing the snapshot management data structure and the set of initial snapshots to the cloud-based storage system.

Still another general aspect includes a storage system that includes: at least one processor; at least one memory; a plurality of data storage devices; means for determining, in the plurality of data storage devices, a plurality of host namespaces configured to store host data; means for creating, on each data storage device among the plurality of data storage devices, a snapshot namespace configured to store snapshots of host data stored in the plurality of host namespaces; means for capturing, for each host namespace, an initial snapshot to determine a set of initial snapshots for the plurality of host namespaces; means for storing the set of initial snapshots to the snapshot namespace distributed among the plurality of data storage devices; and means for storing a snapshot management data structure that includes namespace metadata for the plurality of host namespaces and snapshot metadata for the set of initial snapshots.

The various embodiments advantageously apply the teachings of data storage devices and/or multi-device storage systems to improve the functionality of such computer systems. The various embodiments include operations to overcome or at least reduce the issues previously encountered in storage arrays and/or systems and, accordingly, are more reliable and/or efficient than other computing systems. That is, the various embodiments disclosed herein include hardware and/or software with functionality to improve shared access to non-volatile memory resources by host systems in multi-tenant storage systems, such as by using connection virtualization to enable sharing of back-end non-volatile memory resources. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 provides a block diagram of a storage system configured to automatically manage snapshots for a data storage device array.

FIG. 2 depicts a flowchart of a method for managing snapshots and backup processes in a storage environment, such as the storage system of FIG. 1.

FIGS. 3A-3B show schematic representations of data storage systems with single and multiple enclosure configurations for managing snapshots and metadata.

FIGS. 4A, 4B, and 4C present flowcharts of methods for managing snapshots, snapshot updates, and snapshot retention and offload in a storage system.

FIG. 5 depicts a block diagram of selected components of a storage system, such as the storage system of FIG. 1, related to automatically managing snapshots.

FIGS. 6A and 6B shows a flowchart of a method for managing snapshots in a storage environment, such as the storage system of FIG. 1.

FIG. 7 presents a flowchart of a method for managing incremental updates to snapshots in a storage system, such as the storage system of FIG. 1.

### DETAILED DESCRIPTION

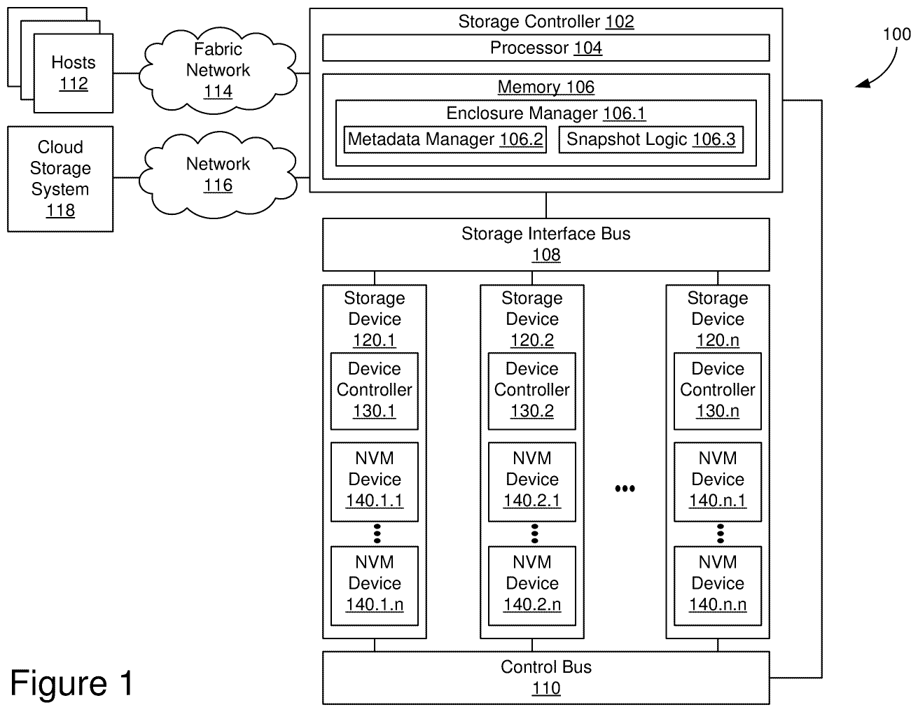

FIG. 1 shows an embodiment of an example data storage system 100 with multiple data storage devices 120 supporting a plurality of host systems 112 through storage controller 102. While some example features are illustrated, various other features have not been illustrated for the sake of brevity and so as not to obscure pertinent aspects of the example embodiments disclosed herein. To that end, as a non-limiting example, data storage system 100 may include one or more data storage devices 120 (also sometimes called information storage devices, storage devices, disk drives, or drives) configured in a storage node with storage controller 102. In some embodiments, storage devices 120 may be configured in a server, storage array blade, all flash array appliance, just-a-bunch-of-flash (JBOF) appliance, or similar storage unit for use in data center storage racks or chassis. Storage devices 120 may interface with one or more host nodes or host systems 112 and provide data storage and retrieval capabilities for or through those host systems. In some embodiments, storage devices 120 may be configured in a storage hierarchy that includes storage nodes, storage controllers, and/or other intermediate components between storage devices 120 and host systems 112. For example, each storage controller 102 may provide a host interface and backplane control functions for a corresponding set of storage devices 120 in a storage node and their respective storage devices may be connected through a corresponding backplane network or internal bus architecture including storage interface bus 108 and/or control bus 110, though only one instance of storage controller 102 and corresponding storage node components are shown. In some embodiments, storage controller 102 may include or be configured within a host bus adapter for connecting storage devices 120 to fabric network 114 for communication with host systems 112.

In the embodiment shown, a number of storage devices 120 are attached to a common storage interface bus 108 for host communication through storage controller 102. For example, storage devices 120 may include a number of drives arranged in a storage array, such as storage devices sharing a common rack, unit, or blade in a data center or the solid state drives (SSDs) in an all flash array or JBOF. In some embodiments, storage devices 120 may share a backplane network, network switch(es), and/or other hardware and software components accessed through storage interface bus 108 and/or control bus 110. For example, storage devices 120 may connect to storage interface bus 108 and/or control bus 110 through a plurality of physical port connections that define physical, transport, and other logical channels for establishing communication with the different components and subcomponents for establishing a communication channel to host 112. In some embodiments, storage interface bus 108 may provide the primary host interface for storage device management and host data transfer, and control bus 110 may include limited connectivity to the host for low-level control functions.

In some embodiments, data storage devices 120 are, or include, solid-state drives (SSDs). Each data storage device 120.1-120.n may include a non-volatile memory (NVM) or device controller 130 based on compute resources (processor(s) and memory) and a plurality of NVM or media devices 140 for data storage (e.g., one or more NVM device(s), such as one or more flash memory devices). In some embodiments, a respective data storage device 120 of the one or more data storage devices includes one or more NVM controllers, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors for interconnecting with storage interface bus 108 and/or control bus 110.

In some embodiments, a respective data storage device 120 may include a single medium device while in other embodiments the respective data storage device 120 includes a plurality of media devices that collectively provide a non-volatile storage medium. In some embodiments, media devices include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels or the like. However, in some embodiments, one or more of the data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes a device controller 130, which includes one or more processing units (also sometimes called central processing units (CPUs), processors, microprocessors, or microcontrollers) configured to execute instructions, alone or in combination, in one or more programs. In some embodiments, the one or more processors are shared by one or more components within, and in some cases, beyond the function of the device controllers. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 are coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. Storage locations may include physical and/or logical locations on storage devices 120 and may be described and/or allocated at different levels of granularity depending on the storage medium, storage device/system configuration, and/or context. For example, storage locations may be allocated at a host logical block address (LBA) data unit size and addressability for host read/write purposes but managed as pages with storage device addressing managed in the media flash translation layer (FTL) in other contexts. Media segments may include physical storage locations on storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks. A logical data group may include a plurality of logical data units that may be grouped on a logical basis, regardless of storage location, such as data objects, files, or other logical data constructs composed of multiple host blocks. In some configurations, the configuration of media segments used to store host data may depend on formatting parameters supported by the storage interface protocol. For example, NVMe drives may support host commands using block formats, scatter-gather lists, and/or scatter-gather lists with key-values.

In some embodiments, storage controller 102 may be coupled to data storage devices 120 through a network interface that is part of host fabric network 114 and includes storage interface bus 108 as a host fabric interface. In some embodiments, host systems 112 are coupled to data storage system 100 through fabric network 114 and storage controller 102 may include a storage network interface, host bus adapter, or other interface capable of supporting communications with multiple host systems 112. Fabric network 114 may include a wired and/or wireless network (e.g., public and/or private computer networks in any number and/or configuration) which may be coupled in a suitable way for transferring data. For example, the fabric network may include any means of a conventional data communication network such as a local area network (LAN), a wide area network (WAN), a telephone network, such as the public switched telephone network (PSTN), an intranet, the internet, or any other suitable communication network or combination of communication networks. From the perspective of storage devices 120, storage interface bus 108 may be referred to as a host interface bus and provides a host data path between storage devices 120 and host systems 112, through storage controller 102 and/or an alternative interface to fabric network 114.

Storage controller 102 may also be connected to a larger or alternative network 116, such as the internet, using one or more network interfaces. In some configurations, network 116 may include overlapping network resources with fabric network 114 but provide a separate network channel for establishing secure data connections using internet protocols to other network resources, such as cloud storage system 118. For example, network 116 may allow storage controller 102 to establish a secure data transfer connection with cloud storage system 118, such as a network storage system accessible through an Amazon web services (AWS) interface.

Host systems 112, or a respective host in a system having multiple hosts, may be any suitable computer device, such as a computer, a computer server, a laptop computer, a tablet device, a netbook, an internet kiosk, a personal digital assistant, a mobile phone, a smart phone, a gaming device, or any other computing device. Host systems 112 are sometimes called a host, client, or client system. In some embodiments, host systems 112 are server systems, such as a server system in a data center. In some embodiments, the one or more host systems 112 are one or more host devices distinct from a storage node housing the plurality of storage devices 120 and/or storage controller 102. In some embodiments, host systems 112 may include a plurality of host systems owned, operated, and/or hosting applications belonging to a plurality of entities and supporting one or more quality of service (QoS) standards for those entities and their applications. Host systems 112 may be configured to store and access data in the plurality of storage devices 120 in a multi-tenant configuration with shared storage resource pools, such as namespaces configured for host data in storage devices 120.

Storage controller 102 may include one or more central processing units (CPUs) or processors 104 for executing compute operations, device management operations, interface protocol offloading, and/or instructions for accessing storage devices 120 through storage interface bus 108. In some embodiments, processors 104 may include a plurality of processor cores which may be assigned or allocated to parallel processing tasks and/or processing threads for different storage operations and/or host storage connections and these processors may operate alone or in combination for completing any given function. In some embodiments, processor 104 may be configured to execute fabric interface for communications through fabric network 114 and/or storage interface protocols for communication through storage interface bus 108 and/or control bus 110. In some embodiments, a separate network interface unit and/or storage interface unit (not shown) may provide the network interface protocol and/or storage interface protocol and related processor and memory resources.

Storage controller 102 may include a memory 106 configured to support an enclosure manager configured executable by processor 104 for managing various device control functions of the appliance or enclosure that includes storage interface bus 108, control bus 110, and storage devices 120. For example, enclosure manager 106.1 may configure and monitor various hardware components in or associated with the enclosure, such as power supplies, network ports, storage bus ports, fans, temperature sensors, etc. In some configurations, enclosure manager 106.1 may be configured for communication through control bus 110 to receive status, operating parameters, interface, error, debug, and other storage device information related to the health or failure of each data storage device and/or its hardware elements and system interfaces.

In the configuration shown, enclosure manager 106.1 is further configured to support automated snapshot management using the storage resources of storage devices 120 and, in some cases, network connection to cloud storage system 118 for offloading or archiving snapshot data. A metadata manager 106.2 may include functions to support collection and maintenance of metadata related to the namespaces defined on storage devices 120 for host data and the snapshots automatically created for those namespaces. Snapshot logic 106.3 may include functions to support the allocation, generation, and storage of those snapshots. Various features of metadata manager 106.2, snapshot logic 106.3, and other functional modules executed by storage controller 102 and/or storage devices 120 will be further described below.

In some embodiments, data storage system 100 includes one or more processors, one or more types of memory, a display and/or other user interface components such as a keyboard, a touch screen display, a mouse, a track-pad, and/or any number of supplemental devices to add functionality and/or support direct administration of storage system 100. In some embodiments, data storage system 100 does not have a display and other user interface components.

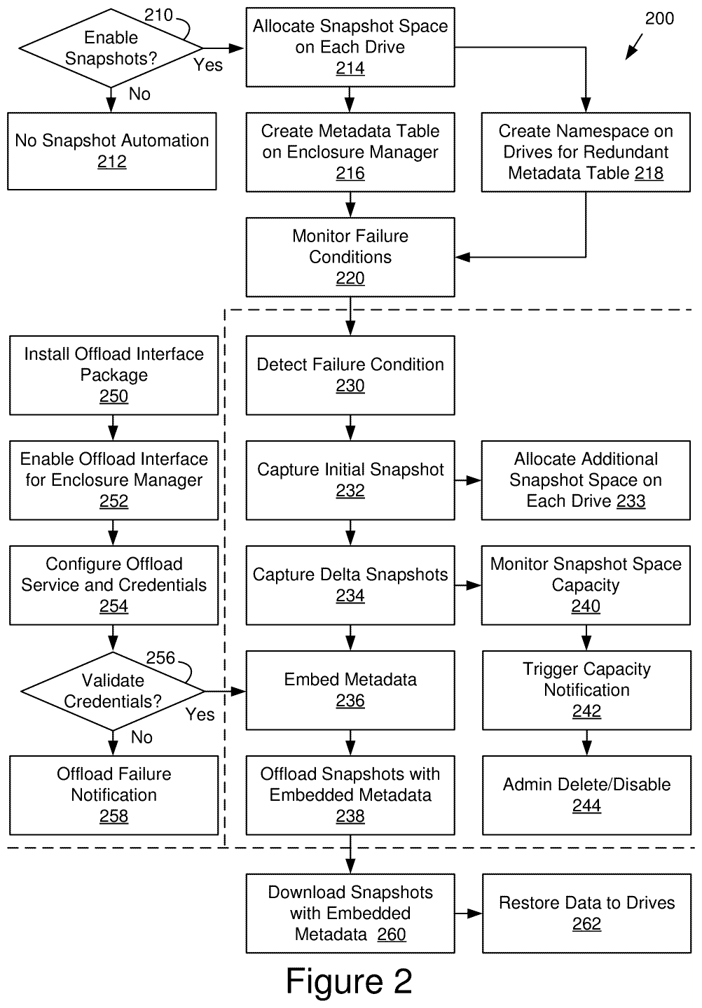

FIG. 2 depicts a flowchart of an example method 200 for managing snapshots and backup processes in a storage environment, such as the storage system of FIG. 1. Blocks 210-220 describe initial configuration of the storage system for automated snapshot management. Blocks 230-238 describe automated snapshot capture in response to a detected failure condition. Blocks 240-244 describe monitoring and reporting of snapshot capacity for administrator intervention. Blocks 250-258 include configuration of snapshot offload to a cloud storage system. Blocks 260-262 describe data restoration based on the offloaded snapshots.

At block 210, the method may begin with a decision to enable snapshots. This decision block determines whether the automated snapshot management feature is activated within the storage system. For example, an administrative indicator, such as a snapshot enable flag, may be set during configuration of the storage system. If the decision is ‘yes’, the method proceeds to block 214, where snapshot space is allocated on each drive. If the decision is ‘no’, the method moves to block 212, indicating that no snapshot automation will occur.

At block 212, no snapshot automation may be enabled and the storage system operates without engaging the snapshot management features. In this state, the storage system may continue with standard data storage operations, but it will not capture snapshots for data protection or recovery purposes on an automated basis.

At block 214, snapshot space may be allocated on each drive. The storage system may allocate a designated portion of storage capacity on each data storage device for storing snapshots. For example, the storage system might reserve a fixed percentage (e.g., 1%) of each drive's total capacity or a predetermined amount of storage space (e.g., 32 GB per drive) that will be used specifically for snapshot data from all of the drives. This may create a virtual snapshot namespace distributed across the set of drives. In some configurations, the size of the space allocation may be configured by the system administrator to increase or decrease the portion of capacity reserved for snapshots.

At block 216, a metadata table may be created on the enclosure manager. In some configurations, the storage system may initialize a metadata table using non-volatile memory controlled by the enclosure manager. For example, the enclosure manager may allocate a 1 GB partition table in memory. This table may contain information about the snapshots, such as their identifiers, timestamps, and the corresponding host namespaces. The metadata table may be used to track and manage the snapshots efficiently across the set of drives in the storage system.

At block 218, a namespace may be created across each drive for a redundantly stored metadata table. In some configurations, the storage system may create one or more private namespaces on the drives, which are used to store redundant copies of the metadata table. This redundancy may ensure that snapshot metadata remains available and intact even in the event of a drive failure or other issues that could compromise data integrity.

At block 220, failure conditions may be monitored. The storage system may continuously monitor the data storage devices and other hardware and software components of the storage system for any failure conditions that could potentially lead to data loss or service interruptions. For example, the enclosure manager may monitor for failure events such as port failures, power failures, drive failures, etc.

At block 230, a failure condition may be detected. The storage system may detect a failure condition based on the monitoring performed in block 220. Upon detection, the method triggers an automatic response to protect the data by generating snapshots of all namespaces on each drive.

At block 232, initial snapshots may be captured for the namespaces. The storage system may automatically initiate the capture of an initial snapshot in response to the detected failure condition. In some configurations, the storage system may create the snapshot namespace in the reserved virtual storage allocation at block 214 as a private virtual namespace using a continuous data mapping format, such as zoned namespace (ZNS) or key-value namespace (KV-NS) and use namespace parameters to determine the order in which snapshots are generated and stored as further described below. As snapshots are created, snapshot metadata may also be captured and updated in the partition table. These initial snapshots may serve as a baseline for the current state of the host data and can be used for recovery if the failure condition leads to data corruption or loss.

At block 233, additional snapshot space may be allocated on each drive. In some configurations, the storage system may, responsive to the initial snapshot capture, allocate additional space for capturing incremental snapshots. For example, the virtual snap space may be expanded or a second virtual snap space may allocated across the drives, such as another 1% or 32 GB of space for storing updated namespaces during the failure condition. The size of the additional snapshot spaces may be the same or different than the initial allocation and may be configurable by the system administrator.

At block 234, delta snapshots may be captured. The storage system may selectively capture updated snapshots that reflect changes in the host data since the initial snapshot was taken. The namespace and snapshot metadata may also be updated. These delta snapshots may be incremental and provide a means to restore the system to any point in time between the initial snapshot and the latest delta snapshot.

At block 236, when snapshot offload has been enabled (see blocks 250-258), metadata may be embedded within the snapshot data for offloading. The storage system may embed the namespace metadata and snapshot metadata within the snapshots themselves. This embedding ensures that the metadata travels with the snapshots during offloading, providing context and facilitating easier recovery processes.

At block 238, the snapshots with embedded metadata may be offloaded to another storage system. The storage system may offload the snapshots, complete with their embedded metadata, to a cloud-based storage system or another offsite location. This offloading is part of a disaster recovery strategy, ensuring that copies of the data are stored securely outside the primary storage environment during the failure condition.

At block 240, the available capacity of the snapshot space may be monitored. The storage system may monitor the capacity of the allocated snapshot space relative to the snapshots that have been created and stored to ensure that there is enough room to store new snapshots as they are captured.

At block 242, capacity notifications may be triggered. The storage system may include one or more trigger conditions, such as periodic reporting of capacity, meeting a capacity threshold (e.g., 80% full), following completion of the initial snapshots or a round of incremental snapshots, etc. If the monitoring in block 240 detects that the snapshot space capacity is nearing its limit (or otherwise meets the trigger conditions), the storage system may triggers a capacity notification. This capacity notification may alert system administrators or automated management systems that action may be required to manage the snapshot space effectively, such as increasing allocated snapshot space, deleting offloaded or redundant data, or changing retention policies.

At block 244, snapshot space may be deleted or disabled by the system administrator. The storage system may provide an option for administrators to disable the snapshot space allocation and reclaim the capacity to use for regular host data namespaces. This action can may be taken at any time by disabling snapshots at block 210 and may result in the loss of any snapshots currently stored in the snapshot virtual namespace(s).

At block 250, an offload interface package may be installed. The storage system may install a web services interface package, such as AWS client packages, for enabling offload of snapshots and metadata to a cloud-based storage system. For example, the web services interface package may be installed as part of firmware installation for the storage system and enable the integration of the storage system with backup and recovery using a cloud-based data bucket.

At block 252, the offload interface may be selectively enabled for the enclosure manager. The storage system may receive a command from the administrator to enable the offload, such as using an application protocol interface (API) plugin and accompanying user interface interface. For example, Amazon's simple storage service (S3) or a similar cloud storage service API may be enabled to communicate with the offloaded data storage solutions.

At block 254, the offload service and credential may be configured. The storage system may receive and store the cloud-based storage service network location and credentials, which may involve specifying the cloud-based storage system details and login and security information for the storage system's access to the data offload location.

At block 256, the credentials for the offload storage system may be validated. The storage system may validate the credentials provided in block 254 by attempting to connect to the cloud-based storage system. If the credentials are valid, the method proceeds to block 236. If the credentials are invalid, the method moves to block 258.

At block 258, an offload failure notification may be generated. The storage system may generate a notification to the administrator indicating that the offload has failed due to invalid credentials or other inability to establish a data transfer connection with the cloud-based storage system. This notification may prompt corrective action to resolve the credential or connection issue.

At block 260, snapshots with embedded metadata may be downloaded from the offload storage system when there is a desire to recover the offloaded data. Once the credentials are validated, the storage system may download some or all of the previously offloaded snapshots, complete with their embedded metadata, from the cloud-based storage system or offsite location to use for restoring the host data in the storage system.

At block 262, host data may be restored to the drives. The storage system may restore the host namespaces and their data from the downloaded snapshots back to the drives within the storage system. This restoration process is part of the recovery operation, bringing the system back to a known good state following a failure condition and/or actual failures and data loss within the storage system.

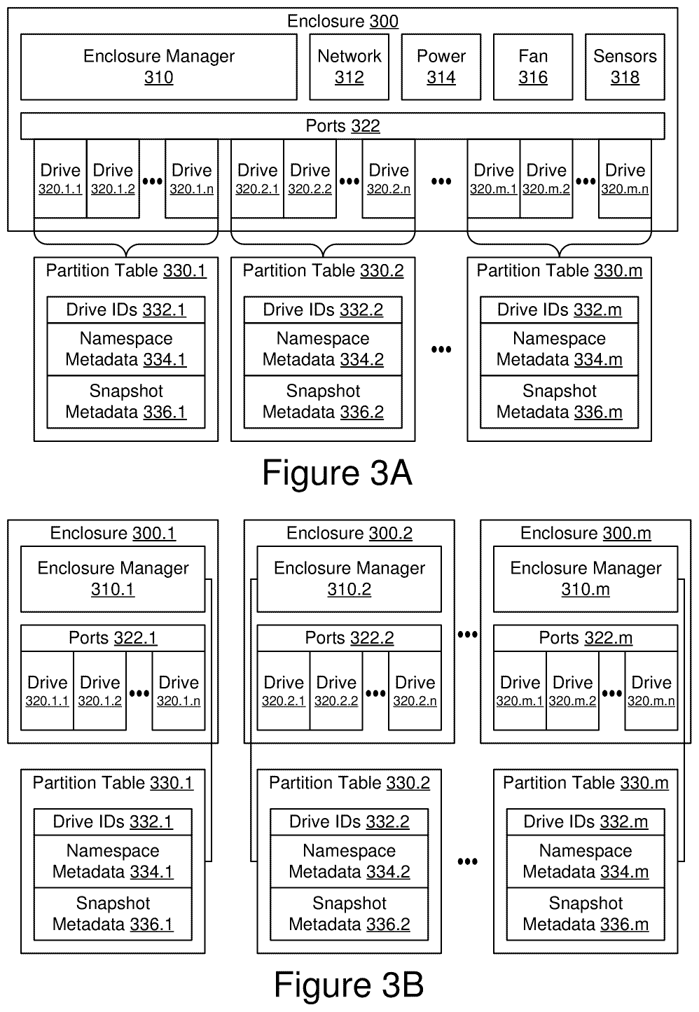

FIG. 3A illustrates an example storage system architecture for a storage enclosure 300 where the partition tables are redundantly stored across drives 320 in enclosure 300. Enclosure 300 may include an enclosure manager 310, which may serve as the central control unit for managing the various components within the enclosure and may also be responsible for coordinating the snapshot operations and handling failure conditions. Enclosure manager 310 may be embodied in software or firmware stored in a memory of enclosure 300 for execution by one or more processors and may include or interface with a plurality of hardware interfaces over an enclosure bus for managing the drives and other subsystems within enclosure 300.

Enclosure manager 310 may be in communication with a network interface 312, which may facilitate connectivity to external networks, including cloud-based storage systems. Enclosure manager 310 may monitor the physical and transport connection between network interface 312 and one or more external networks, such as a fabric network for communication with one or more host systems and/or other network connections for communication with administrative or cloud-based storage systems.

A power controller 314 may be included within enclosure 300 to manage the power supply to the various components, ensuring stable and efficient power distribution. Power controller 314 may manage power connections from an external power source to enclosure 300 and the various components thereof. Power controller 314 may be in communication with enclosure manager 310 (in addition to regulating power to the hardware on which it operates) to allow enclosure manager 310 to monitor power states and power cycling for drives 320 and other components in enclosure 300. For example, enclosure manager 310 may monitor and/or control when specific drives enter low power states or reboot, as well as being able to determine when a drive has lost power.

A fan controller 316 may be present to regulate the cooling mechanisms within the enclosure to manage the operating temperature for the hardware. For example, enclosure 300 may include one or more fan subsystems for exhausting hot air from inside enclosure 300 to the outside of enclosure 300 and the operation and speed of these fans may be monitored by enclosure manager 310. In some configurations, alternate cooling systems, such as fluid-based cooling systems or active heat sinks, may have corresponding controller hardware and/or software in communication with enclosure manager 310.

In some configurations, enclosure 300 may include a sensors interface 318, which may collect data from various sensors deployed throughout the enclosure. This data may be collected by enclosure manager 310 and used to monitor the environmental conditions and the physical state of the enclosure and its components. Example sensors include temperature sensors, humidity sensors, vibration sensors, and other sensors for collecting data indicative of the operating environment and condition of drives 320 in enclosure 300.

Multiple drives, such as drive 320.1, may be housed within the enclosure 300, each containing a portion of the storage capacity of the overall system. These drives may be solid-state drives, hard disk drives, or a combination thereof, and may be configured to operate in unison to provide a large and scalable storage pool. For example, drives 320 may occupy corresponding series of slots including interface ports 322 for the drives. Different enclosures may be configured for different numbers of data storage devices, such 8-drive, 24-drive, or 32-drive configurations. In some configurations, drives 320 may be grouped into sets, groups, or partitions. For example, drives 320.1.1-320.1.n may be a first set of n drives managed as a corresponding partition, drives 320.2.1-320.2.n may be a second set of n drives managed as a second partition, and so on to drives 320.m.1-320.m.n for the mth set of n drives and corresponding partition. As described elsewhere, each drive may include one or more host namespaces for storing host data and one or more private namespaces used by enclosure manager 310 to store snapshots when needed.

Each slot may include at least one corresponding physical port connection to ports 322 to provide a storage interface, control interface, and/or power interface to that drive. For example, each slot may include a peripheral component interconnect express (PCIe) interface that provides a physical connection and uses corresponding protocols for managing communication between the drives and one or more interface buses. Enclosure manager 310 may be configured to monitor the port connections to the drives to determine the operating condition of the port and/or drive. In some configurations, each drive may be supported by multiple ports providing different and/or redundant paths for one or more interface connections.

Enclosure manager 310 may manage partition tables or similar metadata data structures, such as partition tables 330.1-330.m, which may contain metadata about the storage configuration and operations, including drive identifiers 332, namespace metadata 334, and snapshot metadata 336.1. These partition tables may be replicated across multiple drives to ensure high availability and data integrity. For example, partition table 330.1 may be stored on drive 320.1.1, and identical copies of this partition table may be stored on additional drives 320.1.2-320.1.n within enclosure 300. In some configurations, a single partition table may be maintained for all drives in the enclosure and replicated to all or a selection of drives within the enclosure. In some configurations, different partition tables 330.1-330.m may be maintained for different subsets of drives (in this example, corresponding to different sets of physically adjacent drives in a partition) and the redundant copies may be stored across all or at least a plurality of drives in that subset. In other configurations, partition tables may be distributed among and between different subsets of drives to balance redundancy and data availability with the size of and capacity used by redundant copies of one or more partition tables. In some configurations, one or more private namespaces may be created by the enclosure manager on the sets of drives to store the partition table.

FIG. 3B illustrates an alternative storage system architecture comprised of a plurality of enclosures 300.1-300.m, where each enclosure includes a corresponding set of drives. Each enclosure 300.1-300.m may be configured similarly to enclosure 300 in FIG. 3A and may include network and sensor interfaces, power and fan controllers, and similar components. In the configuration shown in FIG. 3A, partition tables 330.1-330.m are stored in the memory of the respective enclosure managers 310.1-310.m. For example, each enclosure manager 310.1-310.m may store and manage a corresponding partition table 330.1-330.m in their respective memories for the set of drives in that enclosure. This may be instead of or in addition to redundantly storing partition tables in a private namespace in the drives. In some configurations, each enclosure manager 310.1-310.m may be configured to redundantly store a copy of its partition table to at least one other location. For example, the enclosure managers may be configured for network communication among and between the enclosures and be able to redundantly store their partition table in the memory of another enclosure manager and perform a similar service for one or more other enclosure managers. In the alternative or in addition to, enclosure managers may selectively store copies of their partition table to one or more private namespaces in one or more drives in their enclosure.

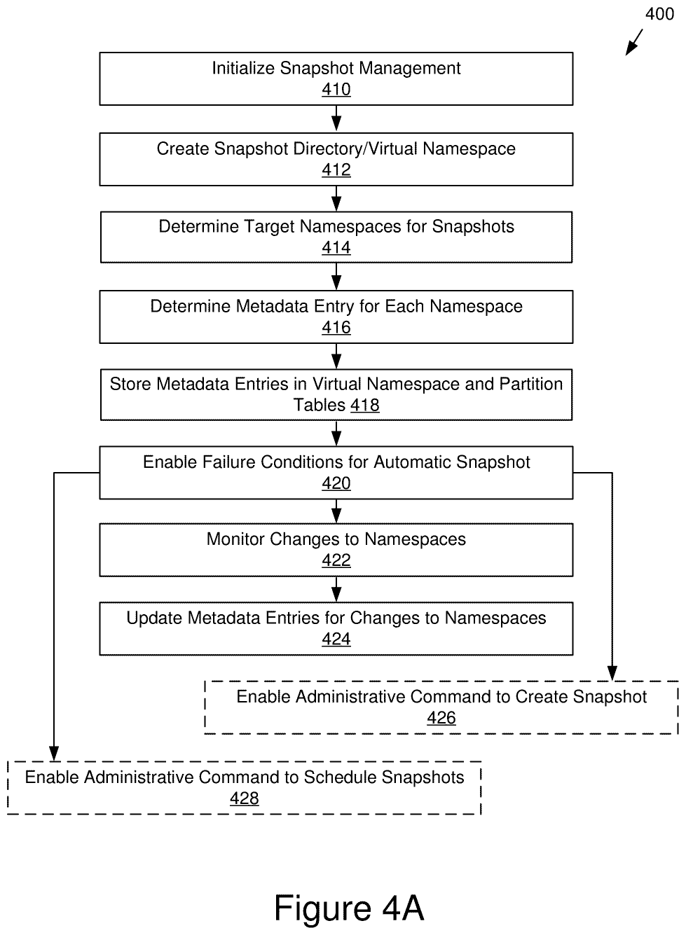

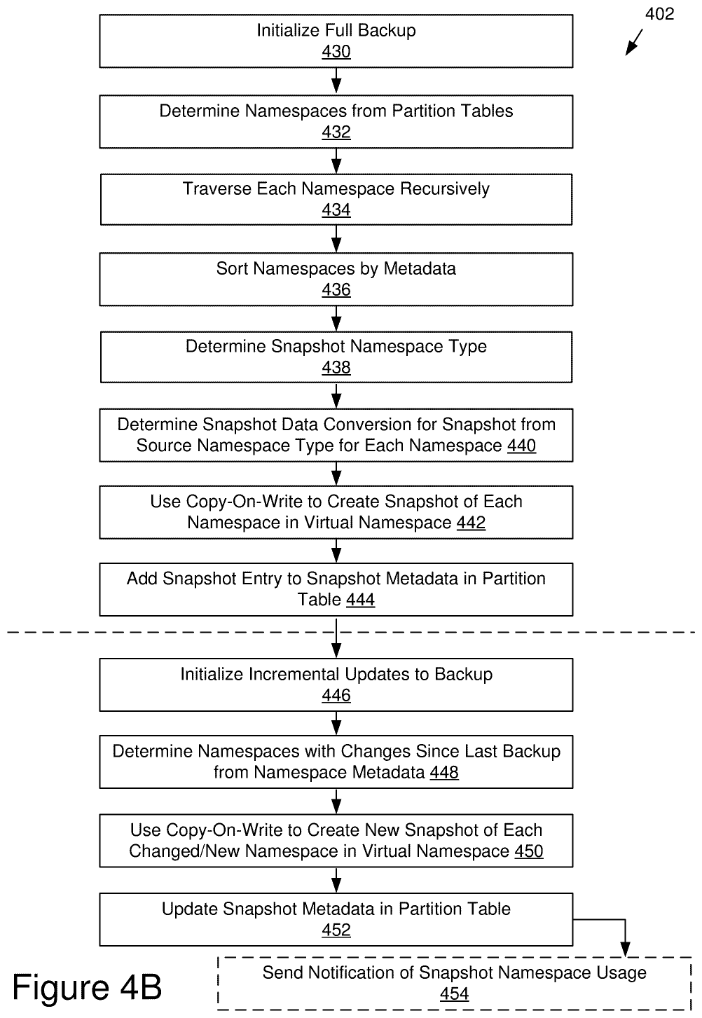

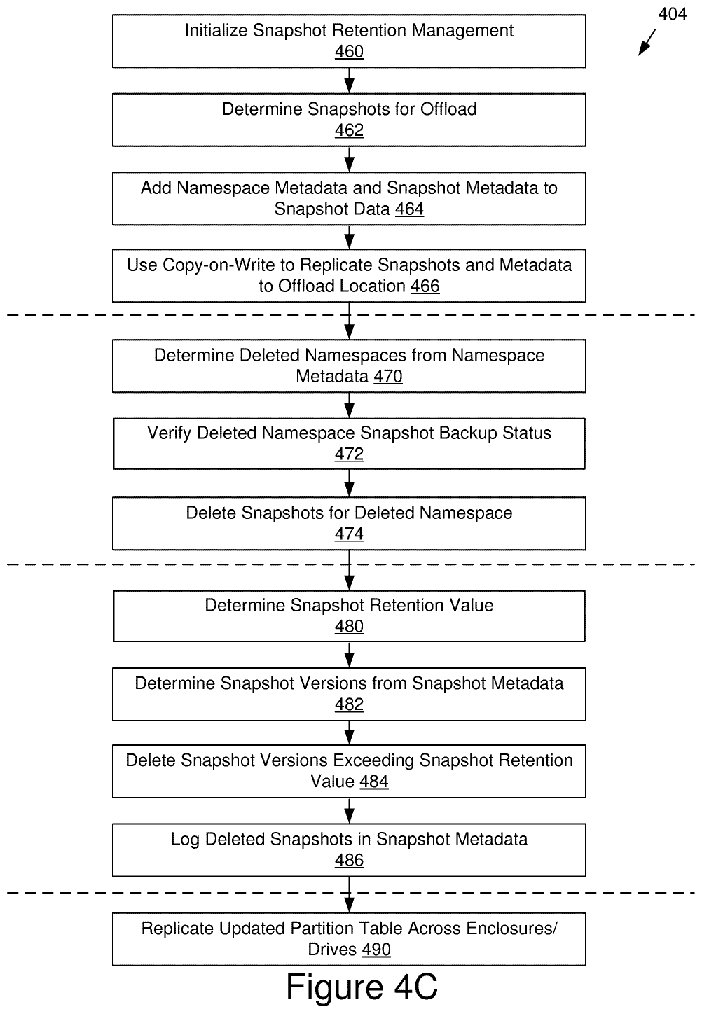

FIG. 4A presents a flowchart of a method 400 for initializing management of snapshots in a storage system. The flowchart outlines the steps involved in the initialization of snapshots within a storage system, such as storage system 100 in FIG. 1, and may operate in conjunction with method 402 in FIG. 4B and method 404 in FIG. 4C for automated management of snapshots.

At block 410, snapshot management may be initialized. This step may involve setting up the initial parameters and configurations for snapshot operations within the storage system. For example, the storage system may receive a snapshot enable flag or similar administrative command for initiating snapshot management.

At block 412, a snapshot directory or virtual namespace may be created. This directory or namespace serves as a dedicated space for storing and organizing the snapshots. For example, the storage system may allocate a portion of its storage capacity to this namespace and distribute it among the data storage devices in the system, ensuring that it is segregated from the host data storage areas and reserved for snapshots.

At block 414, the target namespaces for snapshots may be determined. The storage system may identify which host namespaces are present among the drives and which contain host data. For example, the storage system may scan the host namespaces allocated among the drives and determine their current utilization and other parameters.

At block 416, metadata entries for each namespace may be determined. For example, this step may involve creating or updating metadata entries that describes the namespaces and their utilization, including namespace state (distributed or non-distributed), namespace type (conventional (block) namespace (CNS), ZNS, KV-NS), namespace utilization (NUSE), timestamp, data management service (DMS) details, group, etc. These namespace parameters may be used to classify and sort namespaces to order snapshot operations, as well as assisting in incremental snapshots as needed.

At block 418, metadata entries may be stored in the virtual namespace and partition tables. For example, the storage system may write the namespace metadata to the designated storage locations within the virtual namespace and the partition table of the enclosure manager or distributed among private namespace partition tables in the drives.

At block 420, failure conditions for automatic snapshot capture may be enabled. For example, the storage system may configure monitoring mechanisms, based on the enclosure manager, to detect specific failure conditions, such as hardware malfunctions or software errors, that will automatically trigger the capture of snapshots.

At block 422, changes to namespaces may be monitored. For example, the storage system may continuously observe the host namespaces to identify any modifications to the data, as well as the addition or deletion of host namespaces. This monitoring may be used to determine when updated namespace metadata data is warranted and, after initial snapshots, when incremental snapshots may be needed.

At block 424, metadata entries for changes to namespaces may be updated. For example, when changes are detected, the storage system may update the namespace metadata to reflect the new state of the host namespaces. This ensures that the metadata remains accurate and up-to-date.

Optional blocks 426 and 428 represent additional administrative commands that may be enabled for snapshot management. At block 426, an administrative command to create a snapshot may be enabled, allowing system administrators to manually initiate snapshot captures. Similarly, at block 428, an administrative command to schedule snapshots may be enabled, providing the ability to set up automated snapshot captures based on a predefined schedule.

FIG. 4B presents a flowchart of a method 402 for capturing and updating snapshots in a data storage system. The flowchart details the steps involved in initializing a full backup at blocks 430-444 and incremental updates at blocks 446-452.

At block 430, a full backup may be initialized. For example, the storage system may begin the process of creating a full backup of the data in response to a failure condition detected by an enclosure manager, a scheduled backup, or an administrative command.

At block 432, namespaces may be determined from the partition tables. For example, the storage system may identify the namespaces that require backup by consulting the namespace metadata maintained in the partition tables as described for method 400. The storage system may scan the partition tables to list all the namespaces along with their associated metadata parameters, which will be included in the full backup.

At block 434, each namespace may be traversed recursively. For example, the storage system may traverse each namespace identified at block 432 to ensure that all host namespaces and the host data within the namespace is accounted for in the backup. The storage system might recursively navigate through the table data structure or metadata of each namespace and log their status in the initial snapshot process.

At block 436, namespaces may be sorted by namespace metadata. For example, the storage system may sort the namespaces based on their metadata, which could include criteria such as namespace type, namespace size, data change frequency, or priority levels. For example, the storage system may group namespaces based on their namespace type, then sort them by namespace size, utilization/DMS, and/or namespace groups or zones into various namespace classifications.

At block 438, the snapshot namespace type may be determined. For example, the storage system may determine the type of namespace for the private or virtual namespace that will be used for storing the snapshots. This could involve selecting between different types of virtual namespaces, such as conventional, zoned, key-value, or other specialized namespace types, based on the desired data mapping of the snapshot data.

At block 440, snapshot data conversion for each snapshot from the source namespace type to the snapshot namespace type may be determined. For example, the storage system may determine if any data conversion is necessary when capturing the snapshot from the source namespace type. For instance, the storage system might convert data from a block storage namespace to a sequential write namespace format before capturing the snapshot.

At block 442, copy-on-write (COW) may be used to create each snapshot from a target host namespace into the virtual namespace. For example, the storage system may execute a COW command to create snapshots of each host namespace based on the converted data mapping from block 440.

At block 444, snapshot entries for each snapshot may be added to snapshot metadata in the partition table. For example, the storage system may update the snapshot metadata in the partition table with entries for each new snapshot. The storage system may log the snapshot identifier, timestamp, and other relevant details in the partition table for future reference and management snapshots for updates and recovery.

At block 446, incremental backups may be initiated. For example, the storage system may prepare for capturing incremental changes to the host namespaces without requiring another full backup. The storage system may initiate monitoring of changes to the host data since the last full or incremental backup to initiate snapshots of changed host namespaces. In some configurations, initiating incremental backups may also include allocating additional capacity to the snapshot space, such as by increasing the capacity of the existing virtual namespace or allocating additional virtual namespace(s).

At block 448, namespaces with changes since last backup may be determined from namespace metadata. The storage system may identify which namespaces have experienced changes since the last backup by examining the namespace metadata. The storage system may compare timestamps or other change indicators to determine which namespaces require an updated snapshot.

At block 450, COW may be used to create new snapshots of each changed or new namespace. For example, the storage system may use the data mapping conversion and the COW command again to capture updated snapshots for the changed or new namespaces. In some configurations using zoned namespaces (ZNS) for the snapshot namespace, the COW command may be configured to use a zone random write area feature in the ZNS command set to add the changed data and update the cyclic redundancy check codes of snapshots, as well as any extra information like encrypted keys, versioning, etc. In some configurations, different page sizes may be used in flash translation layers, such as 2K to 4K pages. Data compression, such as binary delta compression may be used to reduce the size of snapshots and only transfer differences in the host data. Example data compression methods may include Kolakoski sequence, Look-and-Say sequence, comparison of graphics file formats, Golomb coding, Burrows-Wheeler transform, recursive indexing, run-length limited encoding, or bitmap index encoding.

At block 452, snapshot metadata may be updated in the partition table. For example, the storage system may update the snapshot metadata in the partition table with information about the new snapshots. This may include adding new snapshot entries with corresponding snapshot identifiers, timestamps, and change logs or version identifiers in the partition table.

At block 454, notification of snapshot namespace usage may be sent. For example, the storage system may monitor the capacity used by the initial backup and each incremental backup to determine when a notification threshold is met and send notifications regarding the usage of the snapshot namespace. For instance, the storage system may alert administrators about the storage utilization of the snapshot namespace when it is nearing full capacity and additional capacity management may be needed to continue incremental snapshots.

FIG. 4C presents a flowchart of a method 404 for managing snapshot retention in a data storage environment. The flowchart outlines the steps involved in initializing snapshot retention management, determining snapshots for offload to backup or archive, and managing the deletion of snapshots. In some configurations, method 404 may operate in conjunction with methods 400 and 402. Blocks 462-466 may describe the offloading of snapshots to another storage system, such as a cloud-based storage system. Blocks 470-474 may describe the management of namespace deletions. Blocks 480-486 may describe management of snapshot retention. Block 490 may describe management of partition tables. These various sub-methods may be employed together as shown or in any combination with each other and methods 400 and 402.

At block 460, snapshot retention management may be initialized within the storage system. For example, the storage system may configure settings for policies that define the retention period for snapshots and establish criteria for when snapshots are to be offloaded and/or deleted.

At block 462, snapshots for offload may be determined. The storage system may identify snapshots that are candidates for offloading to a backup or archive location. For example, the storage system may select all snapshots not previously offloaded or have a more specific set of criteria for determining snapshot offload, such as age of snapshots or characteristics of the corresponding namespace.

At block 464, namespace metadata and snapshot metadata describing the snapshot and corresponding namespace may be added to the snapshot data. For example, the storage system may embed namespace metadata and snapshot metadata within the snapshot data itself.

At block 466, COW may be used to replicate the snapshots and metadata to an offload memory location. For example, the storage system may use a COW command to replicate the snapshots and their embedded metadata to an offload buffer or memory location. In some configurations, data buckets may be used for data transfer and organization of data on the offload storage system, such as a cloud-based storage system, and the snapshot and related metadata may be added to the same data bucket as a single data object with corresponding unique identifier.

At block 470, deleted namespaces may be determined from the namespace metadata. For example, the storage system may traverse the namespace metadata to identify namespaces that have been deleted since the last snapshot was taken.

At block 472, the backup status of deleted namespaces may be verified. For example, the storage system may check the status of snapshots associated with the deleted namespaces in the snapshot metadata to determine whether one or more snapshots of the deleted namespace have previously been offloaded to a backup or archive system. This verification may ensures that snapshots of deleted namespaces are retained according to the retention policy and, in some configurations, confirm that these snapshots are stored remotely before allowing their deletion from the active snapshot storage.

At block 474, snapshots for deleted namespaces may be deleted. For example, the storage system may delete snapshots for namespaces that have been deleted and, if the retention policy for the namespace requires it, confirmed as offloaded and are beyond their retention period.

At block 480, a snapshot retention value may be determined. For example, the storage system may determine the retention value for each namespace and one or more corresponding snapshots. This value could be based on a predefined retention policy or calculated dynamically based on factors such as the frequency of data changes or regulatory requirements.

At block 482, snapshot versions may be determined from snapshot metadata for each namespace. For example, the storage system may identify different versions of snapshots of the same namespace from the snapshot metadata and determine the number of snapshots for the same namespace currently stored in the snapshot virtual namespace.

At block 484, snapshot versions exceeding the snapshot retention value may be deleted. For example, the storage system may delete snapshot versions from the snapshot virtual namespace that exceed the determined retention value to automatically purge older snapshots that are no longer within the retention window and free up snapshot capacity.

At block 486, deleted snapshots may be logged in the snapshot metadata. For example, the storage system may log the deletion of snapshots in the snapshot metadata by marking snapshot entries as deleted but leaving those entries in the partition table. This logging may provide an audit trail that helps in tracking the lifecycle of snapshots within the storage system and may also indicate whether and where the snapshot has been previously offloaded to another system.

At block 490, updated partition tables may be replicated across enclosures and/or drives. For example, the storage system may periodically replicate the updated partition table, which includes the changes made to snapshot metadata and/or namespace metadata across multiple storage locations. This replication may involve distributing the updated partition table to different drives within an enclosure or across multiple enclosures to ensure redundancy and data integrity.

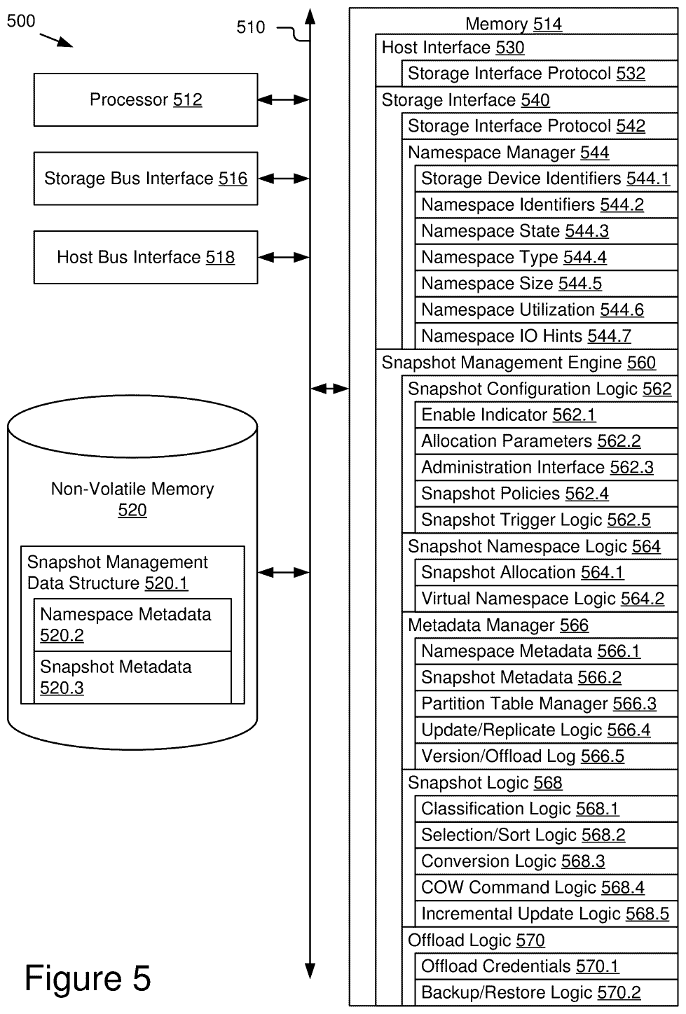

FIG. 5 schematically shows selected modules of a storage system 500 configured for automated snapshot management. Storage system 500 may incorporate elements and configurations similar to those shown in FIGS. 1 and 3A-3B. For example, storage system 500 may be configured as storage controller 102 and a plurality of storage devices 120 supporting host storage operations from host systems 112 over fabric network 114. In some configurations, the components and functions of storage system 500 may be embodied, at least in part, in an enclosure manager 310 operating in an enclosure 300.

Storage system 500 may include a bus 510 interconnecting at least one processor 512, at least one memory 514, and at least one interface, such as storage bus interface 516 and host bus interface 518. Bus 510 may include one or more conductors that permit communication among the components of storage system 500. Processor 512 may include any type of processor or microprocessor that interprets and executes instructions or operations and may include multiple processors operating alone or in combination to execute those instructions or operations. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element. Memory 514 may be comprised of multiple memory devices of one or more types.

Storage bus interface 516 may include a physical interface for connecting to one or more data storage devices using an interface protocol that supports storage device access. For example, storage bus interface 516 may include a PCIe or similar storage interface connector supporting NVMe access to solid state media comprising non-volatile memory devices 520. Host bus interface 518 may include a physical interface for connecting to one or more host systems, generally via a network interface. For example. host bus interface 518 may include an ethernet connection to a host bus adapter, network interface, or similar network interface connector supporting NVMe host connection protocols, such as remote direct memory access (RDMA) and transport control protocol/internet protocol (TCP/IP) connections. In some embodiments, host bus interface 518 may support NVMeoF or similar storage interface protocols.

Storage system 500 may include one or more non-volatile memory devices 520 or similar storage elements configured to store host data. For example, non-volatile memory devices 520 may include a flash memory package or one or more SSDs. In some embodiments, non-volatile memory devices 520 may include administrative storage space allocated on one or more data storage devices in an array of data storage devices connected to storage bus interface 516 and usable by storage system 500 for administrative functions. In some embodiments, non-volatile memory 520 may store a snapshot management data structure 520.1, such as at least one copy of a partition table configured for storing metadata related to a set of drives. For example, a snapshot management space may be allocated in non-volatile memory 520 when snapshots are enabled based on a predetermined administrative space allocations, such as 1 gigabyte (GB). In some embodiments, the snapshot management space may be allocated in a non-volatile memory device in an enclosure that provides memory resources for an enclosure manager and may be on the same circuit board or bus as processor 512 and memory 514. In some embodiments, the snapshot management space may be allocated across a plurality of data storage devices accessible through storage bus interface 516. Redundant copies of snapshot management data structure 520.1 may be distributed across multiple non-volatile memory devices. Snapshot management data structure 520.1 may comprise namespace metadata 520.2 and snapshot metadata 520.3. Namespace metadata 520.2 may include unique namespace identifiers and corresponding namespace parameters and state information for each namespace in storage system 500. For example, each host namespace created in storage system 500 may have a corresponding namespace entry in the partition table associated with that set of drives. Snapshot metadata 520.3 may include unique snapshot identifiers, corresponding namespace identifiers, and snapshot parameters such as snapshot size, timestamp, version, and offload status. For example, each snapshot created in storage system 500 may have a corresponding snapshot entry in the partition table associated with that set of drives. While snapshot management data structure 520.1 is described as a table, other data structures may be employed, such as linked lists, arrays, databases, markup pages, and other data structures.

Storage node 500 may include a plurality of modules or subsystems that are stored and/or instantiated in memory 514 for execution by processor 512 as instructions or operations. For example, memory 514 may include a host interface 530 configured to receive, process, and respond to host connection and data requests from client or host systems. Memory 514 may include a storage interface 540 configured to manage read and write operations to data storage devices in storage system 500. Memory 514 may include a snapshot management engine 560 configured to manage automated creation, storage, and offloading of snapshots of host namespaces.

Host interface 530 may include an interface protocol and/or set of functions and parameters for receiving, parsing, responding to, and otherwise managing requests from host nodes or systems. For example, host interface 530 may include functions for receiving and processing host requests for establishing host connections with one or more volumes or namespaces stored in storage devices for reading, writing, modifying, or otherwise manipulating data blocks and their respective client or host data and/or metadata in accordance with host communication and storage protocols. In some embodiments, host interface 530 may enable direct memory access and/or access over NVMe protocols, such as RDMA and TCP/IP access, through host bus interface 518 and storage bus interface 518 to host data units stored in the data storage devices of storage system 500. For example, host interface 530 may include host communication protocols compatible with ethernet and/or another host interface that supports use of NVMe and/or RDMA protocols for data access to host data 520.1. Host interface 530 may further include host communication protocols compatible with accessing storage node and/or host node resources, such memory buffers, processor cores, queue pairs, and/or specialized assistance for computational tasks.

In some embodiments, host interface 530 may include a plurality of hardware and/or software modules configured to use processor 512 and memory 514 to handle or manage defined operations of host interface 530. For example, host interface 530 may include a storage interface protocol 532 configured to comply with the physical, transport, and storage application protocols supported by the host for communication over host bus interface 518 and/or storage bus interface 516. In some embodiments, storage interface protocol 532 may include both PCIe and NVMe compliant communication, command, and syntax functions, procedures, and data structures. In some embodiments, storage interface protocol 532 may include an NVMeoF or similar protocol supporting RDMA, TCP/IP, and/or other connections for communication between host nodes and target host data, such as volumes or namespaces mapped to the particular host. Storage interface protocol 532 may include interface definitions for receiving host connection requests and storage commands from the fabric network, as well as for providing responses to those requests and commands. In some embodiments, storage interface protocol 532 may assure that host interface 530 is compliant with host request, command, and response syntax while the backend of host interface 530 may be configured to interface with storage interface 540 for directing host storage requests to target drives and namespaces and snapshot management engine 560 to allow host or administrative control over some functions and parameters for snapshot management.

Storage interface 540 may include an interface protocol and/or set of functions and parameters for reading, writing, and deleting data units in corresponding storage devices. For example, storage interface 540 may include functions for executing host data operations related to host storage commands received through host interface 530 once a host connection is established. For example, write commands may be configured to write host data units to memory locations in a designated namespace of a target data storage device. Read commands may be configured to read data from memory locations in the designated namespace of the target storage device. Delete commands may be configured to delete data from memory locations in the designated namespace of the target storage device, or at least mark a data location for deletion until a future garbage collection or similar operation actually deletes the data or reallocates the physical storage location to another purpose.

In some embodiments, storage interface 540 may include a plurality of hardware and/or software modules configured to use processor 512 and memory 514 to handle or manage defined operations of storage interface 540. For example, storage interface 540 may include a storage interface protocol 542 configured to comply with the physical, transport, and storage application protocols supported by the storage devices for communication over storage bus interface 516, similar to or part of storage interface protocol 532. For example, storage interface 540 may include a namespace manager 544 configured to manage metadata related to the namespaces defined in the storage devices of storage system 500.

Namespace manager 544 may include interfaces, functions, parameters, and/or data structures to determine and maintain accurate metadata on the namespaces defined within the storage devices and available to one or more host systems. In some embodiments, namespace manager 544 may manage namespaces for a plurality of storage devices, such as an array of storage devices in storage system 500. Each storage device may be assigned a unique storage device identifier 544.1 and namespace manager 544 may also maintain a set of parameters related to each storage device, such as device type, capacity, interface parameters (interface type, supported queue pairs, queue depth, etc.), port/slot information, etc. For example, namespace manager 544 may include or access a storage device metadata table that includes storage device entries for each storage device. Each namespace may have a unique namespace identifier 544.2 and namespace manager may also maintain a set of namespace parameters related to each namespace. Example namespace parameters may include: namespace state 544.3 including one or more indicator values for distributed or non-distributed namespaces; namespace type 544.4 including one or more indicator values for data mapping types (e.g., CNS, ZNS, KV-NS); namespace size 544.5 including one or more indicator values for the allocated size of the namespace (expected namespace capacity to the host); namespace utilization 544.6 including one or more indicator values for host utilization of he namespace (number of logical blocks currently used by host data in namespace); and namespace input/output (IO) hints including one or more indicator values for IO performance or patterns of host use of the namespace (such as data management service (DMS) hints, operation timestamps, etc.). Other namespace parameters, such as a group or zone the namespace is assigned to, quality of service priority, number of host connections, etc. may also be included. Namespace manager 544 may include or access a namespace metadata table that includes namespace entries for each namespace. For example, namespace manager 544 may determine or capture initial namespace information as namespaces are created on the storage devices and generate corresponding namespace entries in namespace metadata 520.2. Namespace manager 544 may then monitor or query changes (additions, deletions, and parameter changes) and create, delete, or update corresponding namespace metadata entries. Namespace manager 544 may provide namespace metadata to snapshot management engine 560 for supporting snapshot management.

Snapshot management engine 560 may include interface protocols and a set of functions and parameters for providing snapshot management for a set of storage devices and corresponding namespaces using the processing and memory resources of an enclosure manager or similar controller or adapter. For example, snapshot management engine 560 may be configured through an administrative interface to selectively and automatically create and manage snapshots of host namespaces in the storage devices based on one or more trigger conditions and utilizing storage resources distributed among the storage devices. Snapshot management engine 560 may include hardware and/or software modules configured to use processor 512 and memory 514 for executing specific functions of snapshot management engine 560. In some embodiments, snapshot management engine 560 may include snapshot configuration logic 562, snapshot namespace logic 564, metadata manager 566, snapshot logic 568, and offload logic 570.

Snapshot configuration logic 562 may include interfaces, functions, parameters, and/or data structures configured to receive administrative commands to initialize and configure snapshot management. For example, snapshot configuration logic 562 may provide an administrative interface for enabling automated snapshots, setting snapshot memory allocations and policies, and determining when snapshots should be triggered. In some configurations, snapshot configuration logic 562 may receive an administrative command or check a configuration page or similar data structure that provides a snapshot enable indicator 562.1. For example, enable indicator 562.1 may be a flag value received in an administrative command from a system administrator or set in a configuration page using an administration interface 562.3. Enable indicator 562.1 may tell storage system 500 whether or not to enable the snapshot automation functions for one or more sets of storage devices. Snapshot configuration logic 562 may include a snapshot allocation parameter 562.2 configured to determine the size of the storage allocations made for the snapshot namespaces and/or snapshot management data structure 520.1. In some configurations, snapshot allocation parameters 562.2 may include a plurality of values that may configure storage allocations used by snapshot namespace logic 564 for initial and incremental snapshots and/or storage of snapshot management data structure 520.1 in local memory and/or distributed across private namespaces in the storage devices. Snapshot configuration logic 562 may include default values for allocation parameters 562.2 and/or receive custom values from an administrator with enable indicator 562.1 or through administrative interface 562.3.

Administrative interface 562.3 may include a defined command set for administration of snapshot management engine 560 and/or a graphical user interface or API to a general administration interface for the enclosure or storage system to allow an administrator to set and modify parameters and policies for snapshot management engine 560. For example, administration interface 562.3 may provide an interface for an administrator to set enable indicator 562.1 and customize allocation parameters 562.2 during initial configuration of the system. Similarly, administration interface 562.3 may allow selection or customization of snapshot policies 562.4, which may include the trigger conditions used for snapshot trigger logic 562.5. Snapshot policies 562.4 may include a set of default and/or configurable parameters for setting one or more snapshot policies, such as a number of snapshot versions of a namespace to retain, prioritization of snapshot creation, included or excluded namespaces for snapshot creation, timing of incremental snapshots, enabling/configuring snapshot offload for backup or archive, and trigger conditions for initiating snapshot capture. For example, snapshot policies 562.4 may include a number of possible failure conditions and related risk thresholds that are selectable or configurable by the administrative user, such as a fan or port failure, temperature over threshold, drive error rate over threshold, etc. Snapshot trigger logic 562.5 may include functions that monitor parameters and/or receive alerts/interrupts from other components to determine when failure conditions are met and snapshot creation should be initiated. For example, the enclosure manager may monitor failure conditions for components of the enclosure as part of its normal enclosure management operations and may use snapshot trigger logic 562.5 to determine when one of those failure conditions indicates the need to initiate snapshots. In some configurations, snapshot trigger logic 562.5 may support trigger conditions that are not related to failures or predicted failures, such as administrative commands through administration interface 562.3 that allow manual initiation of snapshots or scheduled snapshots.

Snapshot namespace logic 564 may include interfaces, functions, parameters, and/or data structures configured to manage allocations of storage space in the storage devices to the storage of snapshots. For example, snapshot namespace logic 564 may be initiated by snapshot configuration logic 562 when the system is configured (in order to reserve space for at least a full snapshot backup) or on an as needed basis in response to a failure condition or need for space for incremental snapshots. Snapshot namespace logic 564 may include or receive a snapshot allocation 564.1 that includes one or more values to define the storage capacity from the storage devices to be allocated to a private snapshot namespace for administrative use. For example, snapshot configuration logic 562 may provide allocation parameters 562.2 that indicate an initial size for the private namespace to be allocated across each storage device and may include one or more additional values for a metadata namespace for replicating partition tables or snapshot namespace for incremental snapshots. Virtual namespace logic 564.2 may be configured to use snapshot allocation 564.1 to create a virtual namespace on the target set of drives. For example, where snapshot allocation 564.1 indicates a 32 GB snapshot namespace shared among 8 drives, virtual namespace logic 564.2 may create a virtual private namespace distributed across 4 GB on each of the 8 drives. Virtual namespace logic 564.2 may be configured to create the virtual snapshot namespace for sequential data mapping, such as by making the namespace type ZNS or KVNS. This data mapping type may be different than the data mapping types of the host namespaces.

Metadata manager 566 may include interfaces, functions, parameters, and/or data structures configured to manage metadata related to creating and managing snapshots of host namespaces. For example, metadata manager 566 may include logic to generate, access, or query metadata parameters as they are generated or stored by other components and store them in snapshot management data structure 520.1. More specifically, metadata manager 566 may include an interface to namespace manager 544 for accessing namespace metadata 566.1 for the host namespaces in the set of storage devices and may receive snapshot metadata 566.2 from snapshot logic 568 as host namespace snapshots are created and stored. In some configurations, metadata manager 566 may include a partition table manager 566.3 configured to organize and store namespace metadata 566.1 and snapshot metadata 566.2 into one or more partition tables. For example, the partition table for a set of storage devices may include a set of namespace entries corresponding to each host namespace on that set of storage devices and a set of snapshot entries for each snapshot of a host namespace stored on that set of storage devices. Namespace entries and snapshot entries may be populated by metadata manager 566 during an initial or full backup and generate a partition table reflecting the initial state of the host namespaces at the time of the full backup. Metadata manager 566 may further include update and replicate logic 566.4 for managing changes to the namespace and snapshot metadata and to replicate both the initial partition tables and any updated partition tables across multiple storage locations. For example, update logic may include monitoring for changes to namespace metadata 566.1 by namespace manager 544 as host and/or administrative systems change the configuration and state of host namespaces and changes to snapshot metadata 566.2 by snapshot logic 568 as incremental snapshot updates are made over time. Replicate logic may act on both the initial partition tables and any updated partition tables to synchronize copies of the partition tables across multiple storage locations. For example, snapshot configuration logic 562 may determine where and how many copies of partition tables should be maintained and configured whether those copies are distributed in private namespaces in the storage devices and/or across enclosure manager memory in one or more networked enclosures. In some configurations, metadata manager 566 may include one or more logs, such as a version/offload log 566.5 configured to track version identifiers for multiple snapshots of the same host namespace and offload status for indicating whether or not a snapshot has been offloaded to a remote storage system, such as a cloud-based storage system. For example, metadata manager may maintain a series of time-based log entries in addition to the namespace entries and metadata entries in the partition tables or include parameters in the snapshot entries that indicate the version identifier and offload indicator. In some configurations, version/offload log 566.5 may also be configured to manage deletion indicators and/or other parameters related to data retention or other snapshot management policies.

Snapshot logic 568 may include interfaces, functions, parameters, and/or data structures configured to create and store snapshots of the host namespaces to the snapshot namespaces. For example, snapshot logic 568 may use namespace metadata to systematically iterate through all of the host namespaces in a set of storage devices to generate an initial set of snapshots and, in some configurations, make additional iterations to determine incremental updates of selective snapshots. Snapshot logic 568 may include classification logic 568.1 configured to process one or more namespace metadata parameters to classify and group namespaces. For example, classification logic 568.1 may identify namespace types (for data mapping conversion), as well as classify the namespaces within namespace types according to various parameters related to namespace usage, size, and priority for snapshot processing. Selection/sort logic 568.2 may then select and organize the host namespaces into a snapshot order for creation of their respective snapshots. For example, a selection/sort algorithm may operate within namespaces of the same type and then order the namespaces based on a priority algorithm that considers usage categories and size to efficiently use the snapshot space. Conversion logic 568.3 may allow host namespaces written in conventional block namespaces, which may be written in effectively random physical memory locations dependent on a Super Block Manager (SBM) and garbage cycle, to be converted into a sequential namespace format, such as KV-NS or ZNS. For example, conversion logic 568.3 may take the data mapping of the host namespace and convert it to a sequential data mapping for the corresponding snapshot. In some configurations, the mapping information to convert between the data mapping of the host namespace and the data mapping of the snapshot namespace may be stored in the snapshot metadata for that snapshot. Similarly, if additional data is needed to support conversion between namespace types, extra information, such as encrypted keys, versioning, etc., may be appended to the snapshot data in the snapshot namespace. For example, a ZNS snapshot namespace, differential snapshots may use the COW algorithm with a zone random write area feature to write the changed host data to the snapshot and update cyclic redundancy check codes (CRC) of the snapshots to reflect those changes. In some configurations, different page sizes may be used in flash translation layers, such as 2K to 4K pages. Data compression, such as binary delta compression may be used to reduce the size of snapshots and only transfer differences in the host data. Example data compression methods may include Kolakoski sequence, Look-and-Say sequence, comparison of graphics file formats, Golomb coding, Burrows-Wheeler transform, recursive indexing, run-length limited encoding, or bitmap index encoding. COW command logic 568.4 may use COW algorithms to create the snapshots from the host namespaces by copying the host data into the target snapshot namespace format. Incremental update logic 568.5 may be configured to identify changes since the last snapshot of a particular namespace, identify the delta changes since the last snapshot, and copy the namespace into a new location in the snapshot namespace. For example, incremental update logic 568.5 may traverse the namespace metadata to determine changed namespaces and selectively generate new snapshots for those namespaces using classification logic 568.1, selection/sort logic 568.2, conversion logic 568.3, and COW command logic 568.4. In some configurations, snapshot logic 568 may also include snapshot deletion logic configured to delete snapshots in accordance with snapshot policies 562.4 to free up space in the snapshot namespace.

Offload logic 570 may include interfaces, functions, parameters, and/or data structures configured to selectively offload snapshots to another storage system, such as a cloud-based storage system. For example, offload logic 570 may select some or all of the snapshots created and stored in the snapshot namespace and offload them to cloud-based storage for backup or archive purposes. Offload logic 570 may include offload credentials 570.1 configured to store the connection details of the offload storage system, including login and security credentials for establishing a secure data transfer connection between the systems. For example, offload credentials 570.1 may include network storage interface plugin populated with security keys, username, and password for logging into a remote cloud-based storage system over the internet. Offload logic 570 may stage or indicate snapshot data to be transferred to the offload storage system based on copying the snapshot data into a data bucket on the offload system. In some configurations, offload logic 570 may merge the snapshot data with the corresponding namespace and snapshot metadata prior to or during the transfer process such that the relevant metadata is embedded with the snapshot as a single data object in the offload storage system. Backup/restore logic 570.2 may manage and track the snapshots that are offloaded to the offload storage system and enable the recovery and restoration of those snapshots back to storage system 500. For example, as each snapshot is offloaded, parameters indicating the offload, such as an offload location and timestamp, may be logged by metadata manager 566 for that snapshot. If that snapshot is needed to be recovered, similar information may be used to retrieve the snapshot and restore it on the storage devices in storage system 500. The snapshot may initially be restored to the snapshot namespace and then may be converted back to the original data mapping and host namespace to restore the host data.

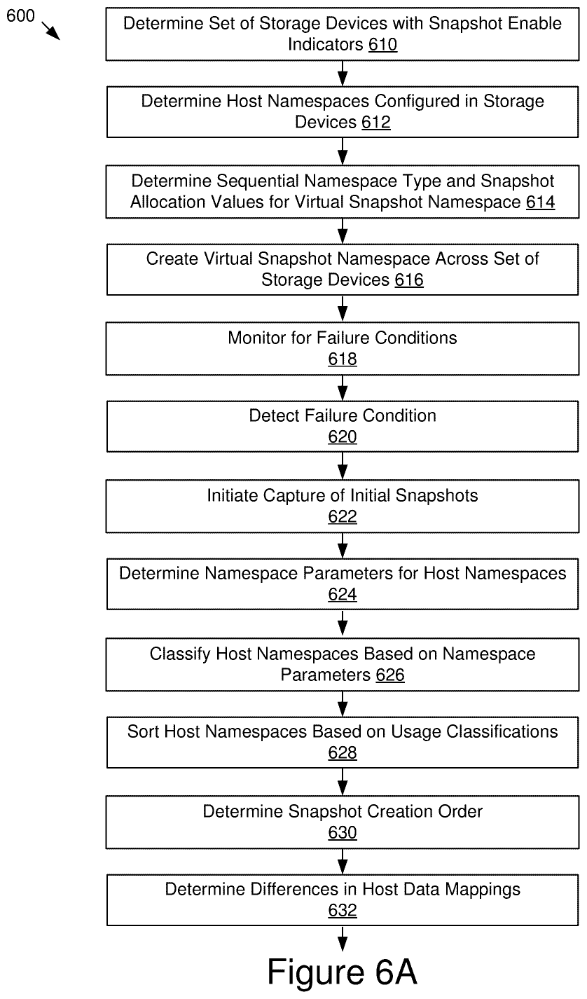

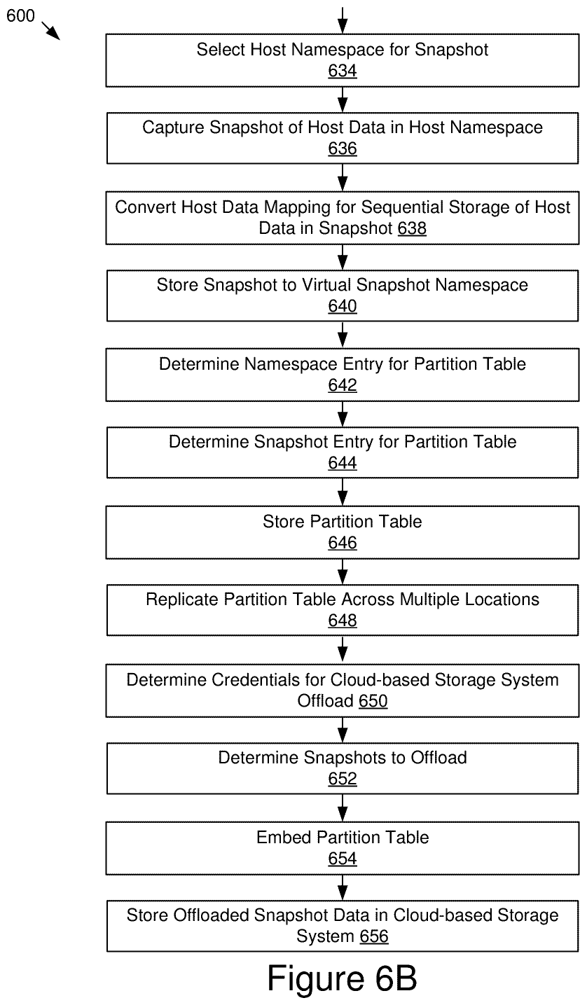

FIGS. 6A and 6B illustrate a flowchart of method 600 for managing automated snapshots in a storage environment. Blocks 610-632 detail the process from the initial setup through the organization of namespaces for snapshot creation. Blocks 634-656 detail the selection of each namespace for snapshot creation through the offloading of snapshot data to a cloud-based storage system.

At block 610, the storage system may identify which sets of storage devices are configured to support snapshots. For example, the system could scan its array of connected storage devices and check the configurations of one or more partitions to determine which ones have the snapshot feature enabled, as indicated by specific configuration flags or settings.

At block 612, the storage system may determine the set of namespaces configured in the storage devices. For example, the system may use a namespace manager to aggregate and track namespace identifiers and corresponding namespace metadata for each namespace in the storage devices enabled for snapshots.

At block 614, the storage system may determine a sequential namespace type and snapshot allocation values for the virtual snapshot namespace. For example, the system may include configuration parameters that determine whether a ZNS or KV-NS should be used for the snapshot namespace and the capacity that should be allocated from each storage device for creation of the virtual snapshot namespace.

At block 616, the storage system may proceed to establish a dedicated virtual namespace on each identified storage device for storing snapshot data. This may involve creating a private virtual namespace on each device specifically for snapshots, distinct from the namespaces used for regular host data storage, that distributes snapshot storage across the set of storage devices.

At block 618, the storage system may actively monitor for specific conditions that would necessitate the capture of snapshots. For example, an enclosure manager may monitor for hardware failures, software errors, or other predefined failure conditions that could compromise data integrity.

At block 620, the storage system may detect a failure condition. For example, the enclosure manager may determine that a failure condition is met based on the state of one or more hardware and/or software subsystems or devices.

At block 622, responsive to detecting a condition that triggers snapshot creation, the storage system may initiate the process of capturing an initial snapshot for each host namespace. For example, the storage system may determine the current set of host namespaces, at the time of the failure condition, from namespace metadata that is in use across the effected storage devices.

At block 624, the storage system may determine various parameters that describe their configuration and usage. For example, the system may access the namespace metadata for the set of namespaces for snapshot. These parameters may include the namespace types, size of the namespace, host IO patterns, and other metrics that are relevant to how the namespace is configured and utilized.

At block 626, based on the parameters analyzed, the storage system may classify each host namespace into usage categories that reflect their usage patterns. This usage classification could be used to prioritize namespaces for snapshot creation based on factors such as host data size, data volatility, or the frequency of access.

At block 628, the storage system may sort the classified namespaces. For example, the system may sort namespaces to optimize the snapshot creation and storage process, potentially arranging the namespaces in an order that aligns with operational priorities, data protection/retention priorities, and/or efficient use of snapshot storage capacity.

At block 630, the storage system may determine the order in which snapshots will be created for the sorted namespaces. This order may dictate the sequence in which the enclosure manager captures and stores the snapshots, influencing the overall efficiency of the snapshot management process. The namespaces may be placed in a snapshot order that enables the snapshots to be created in the enclosure manager and written sequentially into the virtual snapshot namespace distributed among the storage devices without reference to which storage device stores the original host namespace and corresponding host data.

At block 632, the storage system may determine any differences in data mapping formats between the host namespaces and the snapshot namespaces. For example, the system may use the namespace metadata to compare the sequential data mapping type of the snapshot namespace to the different namespace types of each host namespace to identify host namespaces that will need to be converted to the snapshot namespace data mapping for snapshot storage.

At block 634, the storage system may select a host namespace for snapshot capture. For instance, the system could select namespaces based on the previously determined snapshot creation order by selecting the next namespace in the sequence for snapshot capture.

At block 636, the storage system may capture the snapshot of host data within the selected namespace. As an example, the system might execute a snapshot operation that captures the current state of the data within the namespace by reading the host data according to the data mapping of the host namespace.

At block 638, the storage system may convert the host data mapping for sequential storage of the snapshot. This may involve transforming the data layout from the host namespace format to a format that is optimized for sequential write operations within the snapshot namespace, more efficiently utilizing the capacity of the snapshot namespace. For example, the host namespace may have an associated namespace type, such as a block storage namespace type, and the snapshot namespace may have a different associated namespace type, such as a zoned namespace type or a key-value namespace type.

At block 640, the storage system may store the captured snapshot to the snapshot namespace distributed among the storage devices. For example, the system might sequentially write each snapshot to the virtual snapshot namespace and effectively distribute the snapshot data across multiple devices to balance the load and enhance capacity usage and data protection.

At block 642, the storage system may determine the appropriate namespace entry for the partition table. For example, the system may have previously populated namespace metadata entries for each host namespace in preparation for blocks 624-632 and may update the namespace metadata entry corresponding to the host namespace for which the snapshot was created.

At block 644, the storage system may determine the corresponding snapshot entry. For example, the system may generate a set of snapshot parameters for a new snapshot entry in the partition table to reflect the addition of the new snapshot, ensuring that the snapshot management data structure is accurate and up-to-date for each snapshot created.

At block 646, the storage system may store the partition table. For example, the system may store the updated partition table to a designated location within the storage system's memory, such as within the non-volatile memory of the enclosure manager or a private namespace for snapshot administration on one or more storage devices.

At block 648, the storage system may replicate the updated partition table across multiple locations. For instance, the system might distribute copies of the updated partition table to various storage devices or enclosures to maintain redundancy and protect against data loss.

At block 650, the storage system may determine the credentials for offloading snapshots to a cloud-based storage system. For example, the storage system may access authentication and connection details that will be used to establish a secure connection to the cloud storage service.

At block 652, the storage system may identify which snapshots require offloading. For example, the system could select snapshots based on current data backup/archive and retention policies to determine which snapshots are to be transferred to the cloud.

At block 654, the storage system may embed the partition table with the snapshot data to be offloaded. This embedding ensures that the offloaded snapshots include all the information that is pertinent to their management and recovery.

At block 656, the storage system may store the offloaded snapshot data in the cloud-based storage system. As an example, the system might transfer the snapshots, complete with their embedded metadata, to the cloud storage service for long-term retention and disaster recovery purposes.

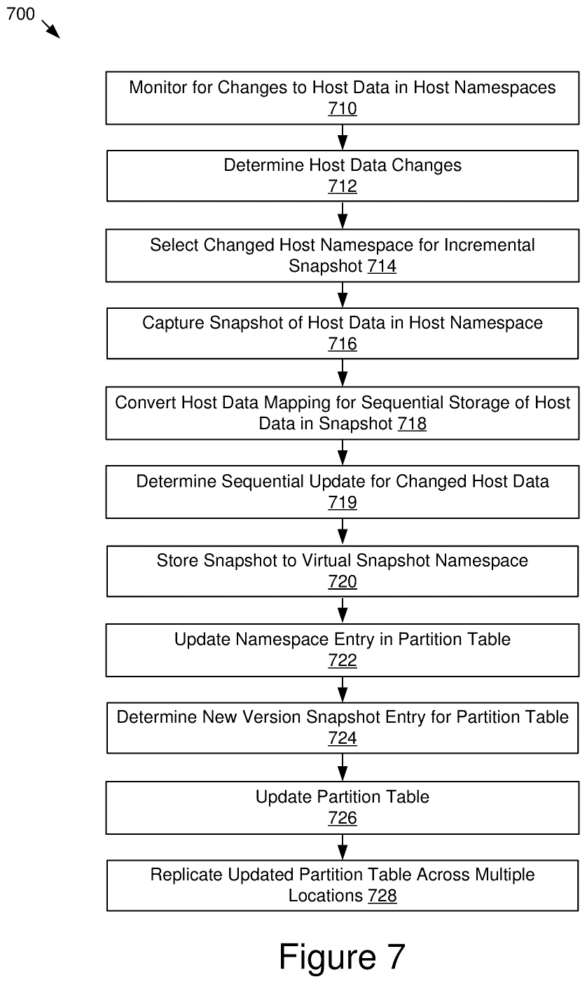

FIG. 7 presents a flowchart of method 700, which outlines the steps for managing incremental updates to snapshots in a storage system.

At block 710, the storage system may monitor changes to host data within the host namespaces. For instance, the system could employ a monitoring service that tracks data modifications in real-time based on host IO and/or changes to namespace metadata, flagging any alterations that occur within the host namespaces since the last snapshot was captured.

At block 712, the storage system may identify host data changes in at least one host namespace. As an example, the system might compare the current state of the data based on host data size or write timestamp against the state captured in the last snapshot and reflected in namespace and/or snapshot metadata, identifying the differences that constitute the changes.

At block 714, the storage system may select a changed host namespace for capturing an updated snapshot. For example, the system could prioritize the changed namespaces based on the extent of the changes or the impact on the overall data integrity, selecting the next namespace for an incremental snapshot update.

At block 716, the storage system may capture a snapshot of the host data within the selected namespace. For example, the system may create a new snapshot that includes all the recent changes using a method similar to method 600 in FIG. 6B above.

At block 718, the storage system may convert the host data mapping for sequential storage of the updated snapshot. For example, the storage system may use the converted data mapping for the host namespace type in the prior snapshot and convert the changed host data to be compatible with the data mapping in the snapshot namespace type.

At block 719, the storage system may determine a sequential update for changed host data selected at block 714. For example, the storage system may use a COW command with a zoned random write feature to add changed data units in a sequential update to the previously stored snapshot for that host namespace.

At block 720, the storage system may store the updated snapshot in the snapshot namespace. For instance, the system could write the new snapshot data to the designated snapshot namespace using COW to reference the unchanged host data in the prior snapshot and add the changed host data sequentially in an update snapshot namespace.

At block 722, the storage system may update the namespace entry in the partition table to reflect the namespace changes and/or the new snapshot. This may include modifying the namespace entry for the changed host namespace in the partition table.

At block 724, the storage system may determine a new snapshot entry for the updated snapshot. For example, the system might generate a new set of snapshot parameters for a new snapshot entry in the partition table and include a a new timestamp and/or version identifier to uniquely identify the snapshot relative to prior snapshots of that host namespace.

At block 726, the storage system may store the updated partition table. The system may write the revised partition table to a memory location within the storage system, where it can be accessed for future snapshot management operations.

At block 728, the storage system may replicate the updated partition table across multiple storage locations. For instance, the system might distribute the updated partition table to different drives within an enclosure or across multiple enclosures to ensure redundancy and data integrity.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A system, comprising:
at least one memory; and
at least one processor configured to, alone or in combination, execute instructions to:
determine a plurality of data storage devices comprising a plurality of host namespaces configured to store host data;
create, on each data storage device among the plurality of data storage devices, a snapshot namespace configured to store snapshots of host data stored in the plurality of host namespaces;
capture, for each host namespace, an initial snapshot to determine a set of initial snapshots for the plurality of host namespaces;
store the set of initial snapshots to the snapshot namespace distributed among the plurality of data storage devices; and
store a snapshot management data structure comprising:
namespace metadata for the plurality of host namespaces; and
snapshot metadata for the set of initial snapshots.

2. The system of claim 1, wherein the at least one processor is further configured to, alone or in combination, execute instructions to:
monitor the plurality of data storage devices for at least one failure condition;
detect the at least one failure condition; and
automatically initiate, responsive to detecting the at least one failure condition, capturing the initial snapshots for the set of initial snapshots for the plurality of host namespaces.

3. The system of claim 1, wherein the at least one processor is further configured to, alone or in combination, execute instructions to, responsive to determining the set of initial snapshots for the plurality of host namespaces:
monitor the plurality of host namespaces to determine host data changes in at least one host namespace of the plurality of host namespaces;
capture, for each host namespace of the at least one host namespace having the host data changes, an updated snapshot to determine a set of update snapshots for the plurality of host namespaces;
store the set of update snapshots to the snapshot namespace distributed among the plurality of data storage devices; and
update the snapshot management data structure with changes to:
the namespace metadata for the plurality of host namespaces; and
the snapshot metadata for the set of initial snapshots.

4. The system of claim 1, wherein the at least one processor is further configured to, alone or in combination, execute instructions to:
determine, for each host namespace, a host namespace type for that host namespace;
determine, for the snapshot namespace, a snapshot namespace type that is different from the host namespace type of at least one host namespace of the plurality of host namespaces; and
convert, prior to storing the host data from the at least one host namespace having the host namespace type that is different from the snapshot namespace type to the set of initial snapshots, host data mapping for that host namespace type to host data mapping for the snapshot namespace type.

5. The system of claim 4, wherein:
the host namespace type for the at least one host namespace having the host namespace type that is different from the snapshot namespace type is a block storage namespace type; and
the snapshot namespace type is a sequential write namespace type selected from:
a zoned namespace type; and
a key-value namespace type.

6. The system of claim 1, wherein the at least one processor is further configured to, alone or in combination, execute instructions to:
determine, for each host namespace of the plurality of host namespaces, a set of namespace parameters;
classify, based on the set of namespace parameters for each host namespace, a usage classification for that host namespace;
sort the plurality of host namespaces by their usage classifications; and
determine, based on the sorted plurality of host namespaces, a snapshot creation order for the set of initial snapshots that determines sequential storage of the set of initial snapshots in the snapshot namespace.

7. The system of claim 1, wherein:
the at least one processor is further configured to, alone or in combination, execute instructions to determine a snapshot allocation value for each data storage device of the plurality of data storage devices; and
the snapshot namespace comprises, for each data storage device of the plurality of data storage devices, a portion of a capacity of that data storage device based on the snapshot allocation value.

8. The system of claim 1, wherein the at least one processor is further configured to, alone or in combination, execute instructions to replicate the snapshot management data structure across multiple storage locations selected from:
non-volatile memory in each data storage device of the plurality of data storage devices; and
non-volatile memory in each storage enclosure of a plurality of storage enclosures comprising the plurality of data storage devices.

9. The system of claim 1, further comprising:
a storage enclosure comprising:
a network interface in communication with a cloud-based storage system configured to store offloaded snapshot data;
the plurality of data storage devices;
the at least one memory; and
the at least one processor, wherein the at least one processor is further configured to, alone or in combination, execute instructions to:
determine a set of credentials for the cloud-based storage system;
embed the snapshot management data structure with the set of initial snapshots; and
store the snapshot management data structure and the set of initial snapshots to the cloud-based storage system.

10. The system of claim 9, wherein:
each data storage device of the plurality of data storage devices is a solid state drive comprising:
a non-volatile storage medium;
a device controller configured to control storage operations to the non-volatile storage medium; and
a storage interface port configured to connect to a storage interface bus of the storage enclosure; and
the storage enclosure further comprises:
at least one power interface configured to provide power to the plurality of data storage devices;
at least one fan configured to cool the plurality of data storage devices; and
an enclosure manager stored in the at least one memory for execution by the at least one processor, alone or in combination, to monitor for a plurality of failure conditions selected from:
failure of at least one data storage device of the plurality of data storage devices;
failure of at least one port connected to the storage interface bus;
failure of at least one power connection to at least one data storage device through the at least one power interface; and
failure of the at least one fan.

11. A computer-implemented method, comprising:
determining a plurality of data storage devices comprising a plurality of host namespaces configured to store host data;
creating, on each data storage device among the plurality of data storage devices, a snapshot namespace configured to store snapshots of host data stored in the plurality of host namespaces;
capturing, for each host namespace, an initial snapshot to determine a set of initial snapshots for the plurality of host namespaces;
storing the set of initial snapshots to the snapshot namespace distributed among the plurality of data storage devices; and
storing a snapshot management data structure comprising:
namespace metadata for the plurality of host namespaces; and
snapshot metadata for the set of initial snapshots.

12. The computer-implemented method of claim 11, further comprising:
monitoring the plurality of data storage devices for at least one failure condition;
detecting the at least one failure condition; and
automatically initiating, responsive to detecting the at least one failure condition, capturing the initial snapshots for the set of initial snapshots for the plurality of host namespaces.

13. The computer-implemented method of claim 11, further comprising, responsive to determining the set of initial snapshots for the plurality of host namespaces:
monitoring the plurality of host namespaces to determine host data changes in at least one host namespace of the plurality of host namespaces;
capturing, for each host namespace of the at least one host namespace having the host data changes, an updated snapshot to determine a set of update snapshots for the plurality of host namespaces;
determining, for at least one host namespace having the host data changes, at least one changed data unit for sequentially updating a previously stored snapshot for the at least one host namespace having the host data changes;
storing the set of update snapshots to the snapshot namespace distributed among the plurality of data storage devices; and
updating the snapshot management data structure with changes to:
the namespace metadata for the plurality of host namespaces; and
the snapshot metadata for the set of initial snapshots.

14. The computer-implemented method of claim 11, further comprising:
determining, for each host namespace, a host namespace type for that host namespace;
determining, for the snapshot namespace, a snapshot namespace type that is different from the host namespace type of at least one host namespace of the plurality of host namespaces; and
converting, prior to storing the host data from the at least one host namespace having the host namespace type that is different from the snapshot namespace type to the set of initial snapshots, host data mapping for that host namespace type to host data mapping for the snapshot namespace type.

15. The computer-implemented method of claim 14, wherein:
the host namespace type for the at least one host namespace having the host namespace type that is different from the snapshot namespace type is a block storage namespace type; and
the snapshot namespace type is a sequential write namespace type selected from:
a zoned namespace type; and
a key-value namespace type.

16. The computer-implemented method of claim 11, further comprising:
determining, for each host namespace of the plurality of host namespaces, a set of namespace parameters;
classifying, based on the set of namespace parameters for each host namespace, a usage classification for that host namespace;
sorting the plurality of host namespaces by their usage classifications; and
determining, based on the sorted plurality of host namespaces, a snapshot creation order for the set of initial snapshots that determines sequential storage of the set of initial snapshots in the snapshot namespace.

17. The computer-implemented method of claim 11, further comprising:
determining a snapshot allocation value for each data storage device of the plurality of data storage devices, wherein the snapshot namespace comprises, for each data storage device of the plurality of data storage devices, a portion of a capacity of that data storage device based on the snapshot allocation value.

18. The computer-implemented method of claim 11, further comprising:
replicating the snapshot management data structure across multiple storage locations selected from:
non-volatile memory in each data storage device of the plurality of data storage devices; and
non-volatile memory in each storage enclosure of a plurality of storage enclosures comprising the plurality of data storage devices.

19. The computer-implemented method of claim 11, further comprising:
determining a set of credentials for a cloud-based storage system in communication with a storage enclosure comprising the plurality of data storage devices;
embedding the snapshot management data structure with the set of initial snapshots; and
storing the snapshot management data structure and the set of initial snapshots to the cloud-based storage system.

20. A storage system comprising:
at least one processor;
at least one memory;
a plurality of data storage devices;
means for determining, in the plurality of data storage devices, a plurality of host namespaces configured to store host data;
means for creating, on each data storage device among the plurality of data storage devices, a snapshot namespace configured to store snapshots of host data stored in the plurality of host namespaces;
means for capturing, for each host namespace, an initial snapshot to determine a set of initial snapshots for the plurality of host namespaces;
means for storing the set of initial snapshots to the snapshot namespace distributed among the plurality of data storage devices; and
means for storing a snapshot management data structure comprising:
namespace metadata for the plurality of host namespaces; and
snapshot metadata for the set of initial snapshots.
